(19) United States
(12) Patent Application Publication
(10) Pub. No.: US 2025/0131149 A1
(43) Pub. Date: Apr. 24, 2025

(54) DESIGN SUPPORT DEVICE, DESIGN SUPPORT METHOD, AND PROGRAM

(71) Applicant: TOYO ENGINEERING CORPORATION, Minato-ku, Tokyo (JP)

(72) Inventors: Makoto ITO, Narashino-shi, Chiba (JP); Satoshi MIYAZAWA, Narashino-shi, Chiba (JP)

(73) Assignee: TOYO ENGINEERING CORPORATION, Minato-ku, Tokyo (JP)

(21) Appl. No.: 18/723,106

(22) PCT Filed: Sep. 27, 2022
(86) PCT No.: PCT/JP2022/035942

§ 371 Date: Jun. 21, 2024

(30) Foreign Application Priority Data
Dec. 23, 2021 (JP) 2021-209686

(51) Int. Cl. G06F 30/18; G06F 30/12; G06F 111/20; G06F 113/14

(52) U.S. Cl. CPC G06F 30/18; G06F 30/12; G06F 2111/20; G06F 2113/14

(57) ABSTRACT

A design support device (10) acquires conditions and spatial information for constructing a component, searches a database (20) for combinations of parts that satisfy the acquired conditions, displays on a display device a display screen showing the retrieved combinations of parts, determines the arrangement of the parts in the component based on the spatial information and the shape and dimension of each of the parts constituting a combination selected from among the combinations displayed on the display device, and displays on the display device the information indicating the determined arrangement.

### TECHNICAL FIELD

This invention relates to a design support device, a design support method, and a program.

### BACKGROUND OF ART

Patent Document 1 discloses a design support device equipped with the following functions: the design support device reads piping layout graphic data, model-specific support pattern graphic data, support installation position data, and frame and perimeter layout information data from a memory device; the design support device then outputs and displays the model-specific support pattern graphic data on a display device based on the read data; the design support device then reads the primary support data, support design condition data, and support catalog item data for the displayed pattern for support selection; finally, the design support device then selects support catalog items from these read data and calculates the strength of the selected supports.

In recent years, computer-aided design (CAD) and other computer-aided design tools are commonly used, for example, when designing structures. CAD tools are customized for different situations. For example, Patent Document 2 discloses a technology that, when displaying on screen a piping diagram of control units constituting a plant, displays a control unit that satisfies specified conditions in such a way that it can be distinguished from other control units.

### PRIOR ART DOCUMENTS

### Patent Documents

Patent Document 1: Patent Publication No. 5-110412

Patent Document 2: U.S. Pat. No. 6,228,681

### SUMMARY OF THE INVENTION

### Problem to be Solved by the Invention

In general CAD tools, it is necessary to input information from the outside to indicate how parts are to be arranged in a component that consists of multiple parts. The problem therefore arises that time and effort must be expended to arrange the parts that make up the component.

The purpose of the present invention is to provide a design support device, a design support method, and a program that can easily arrange parts that constitute a component.

### Means for Solving the Problem

The design support device of the present invention comprises: an information acquisition unit that acquires spatial information and conditions for constructing a component;
a search unit that searches a database for combinations of parts that satisfy the conditions acquired by the information acquisition unit;
a display control unit that displays on a display device a display screen showing the combinations of parts retrieved from the database by the search unit; and
an arrangement determining unit that determines an arrangement of the parts in the component based on the spatial information and the shape and dimensions of each of the parts constituting a combination selected from among the combinations displayed on the display device by the display control unit,
wherein the display control unit displays on the display device information indicating the arrangement determined by the arrangement determining unit.

The design support method of the present invention comprises:
a process of acquiring spatial information and conditions for constructing a component;
a process of searching a database for combinations of parts that satisfy the acquired conditions for constructing the component;
a process of outputting the combinations of parts retrieved from the database;
a process of determining an arrangement of the parts in the component that comprises the parts based on the spatial information and the shape and dimensions of each of the parts that make up a combination selected from among the output combinations; and
a process of outputting information indicating the determined arrangement.

The program of the present invention is a program for causing a computer to execute:
a procedure for acquiring spatial information and conditions for constructing a component;
a procedure for searching a database for combinations of parts that satisfy the acquired conditions for constructing the component;
a procedure for outputting the combinations of parts retrieved from the database;
a procedure for determining an arrangement of the parts in the component that comprises the parts based on the spatial information and the shape and dimensions of each of the parts that make up a combination selected from among the output combinations; and
a procedure for outputting information indicating the determined arrangement.

### Advantageous Effects of the Invention

In the present invention, parts that make up a component can be easily arranged.

### BRIEF DESCRIPTION OF THE DRAWINGS

FIG. 1 shows an embodiment of a design support device.

FIG. 2 shows an example of the constituent elements provided in the design support device shown in FIG. 1.

FIG. 3 is a flowchart for explaining an example of a design support method in the embodiment shown in FIG. 1.

FIG. 4 shows an example of a display screen displaying combinations of parts in Step S3.

FIG. 5 shows an example of a display screen displaying combinations of parts in Step S6.

FIG. 6 shows an example of parts read from a database in Step S8.

FIG. 7 is a figure for explaining a specific example of the process of determining an arrangement of parts by the arrangement determining unit in Step S9.

FIG. 8 shows an example of a display of an arrangement of parts that is displayed on a display device by the display control unit in Step S10.

FIG. 9 shows an example of a drawing displayed using a 3D CAD model. Description of the Embodiments

An embodiment of the invention is next described with reference to the drawings.

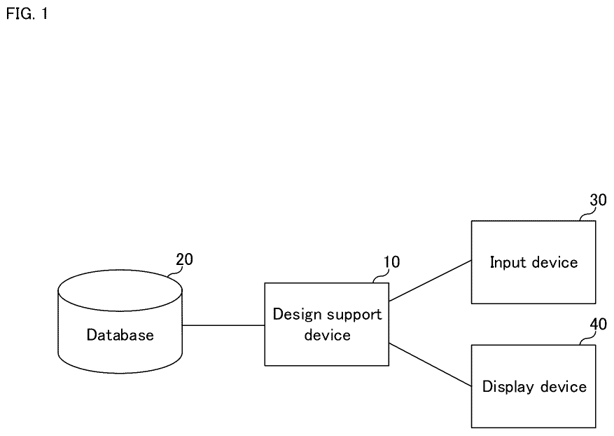

FIG. 1 shows an embodiment of a design support device of the present invention. As shown in FIG. 1, this embodiment comprises design support device 10, database 20, input device 30, and display device 40. Database 20 stores in advance information about structures (e.g., piping, etc.) that will be the object of design and a supporting component that will support the structures. Database 20 may store information about the structures in association with information about the support component that supports these structures that corresponds with the information about the structures. Information about the support component includes information about the parts that make up the support component. The information stored in database 20 includes, for example, specifications of each structure (application, identification, size, material, insulating performance, coating type of piping, etc.), specifications of a support component for supporting structures (identification, shape, dimensions, strength, material, fireproof coating, etc.), and combinations of parts that make up each structure and support component. Design support device 10 reads this information from database 20 and performs the prescribed processing. Input device 30 accepts operations from the outside. Input device 30 supplies information to design support device 10 based on accepted operations. Input device 30 is a peripheral device such as a touch panel, keyboard, mouse, or microphone for user input of information. Display device 40 is a display device that displays information according to display control signals from design support device 10.

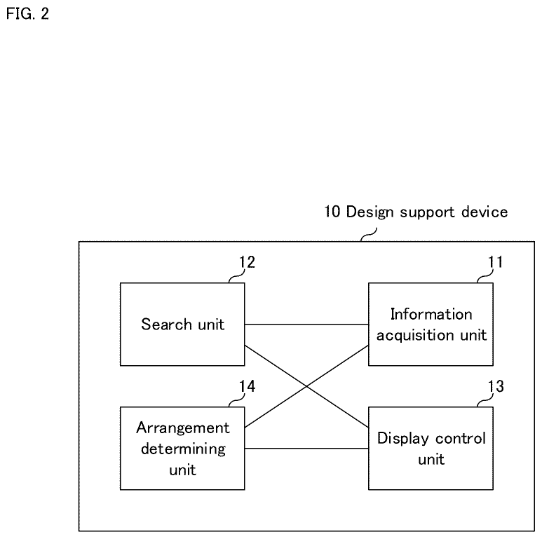

FIG. 2 shows an example of the constituent elements provided in design support device 10 shown in FIG. 1. As shown in FIG. 2, design support device 10 shown in FIG. 1 has information acquisition unit 11, search unit 12, display control unit 13, and arrangement determining unit 14. FIG. 2 shows, of the constituent elements provided in design support device 10 shown in FIG. 1, the main constituent elements relating to this embodiment.

Information acquisition unit 11 accepts operations from the outside. Information acquisition unit 11 acquires information based on the accepted operations. Information acquisition unit 11 may, for example, acquire information from a touch panel, keyboard, mouse, microphone, or other peripheral device (input device 30) for user input. Information acquisition unit 11 has an interface function with peripheral devices. Information acquisition unit 11 outputs to search unit 12 information based on operations accepted by peripheral devices.

Search unit 12 searches database 20 for information according to the information acquired by information acquisition unit 11. Specifically, search unit 12 searches database 20 for combinations of parts constituting support components that support the piping indicated by the piping information acquired by information acquisition unit 11 and that is associated with the piping information. Alternatively, search unit 12 calculates combinations of parts that can constitute a support component capable of supporting piping that satisfies the parameters and characteristics included in the piping information acquired by information acquisition unit 11, and searches database 20 for the calculated combinations of parts. This calculation method may, for example, be a method generated based on past search results. This calculation method may also be, for example, a method that uses a learned model realized by machine-learning combinations of parts suitable for the piping information. Search unit 12 outputs the retrieved combination of parts to display control unit 13. Alternatively, search unit 12 searches database 20 for combinations of parts that satisfy the conditions acquired by information acquisition unit 11. Search unit 12 outputs the retrieved combinations of parts to display control unit 13.

Display control unit 13 displays the information output from search unit 12 on display unit 40. Specifically, display control unit 13 outputs display control signals to display unit 40 for display unit 40 to display the information output from search unit 12. The display screen displayed on display unit 40 by display control unit 13 is configured to allow the user to select a desired combination of parts from among combinations of parts. The user can select the desired combination by operating a touch panel, keyboard, mouse, microphone, or other terminals while checking the display screen displayed by display unit 40. Information acquisition unit 11 accepts the selection information. Arrangement determining unit 14 acquires the information acquired by information acquisition unit 11. Display control unit 13 outputs information indicating the arrangement determined by arrangement determining unit 14 based on the information acquired by arrangement determining unit 14. The output method of information indicating the arrangement determined by arrangement determining unit 14 in display control unit 13 can be, for example, display, audio output, printing, or transmission to other devices. Display control unit 13 may display the information output from search unit 12 as a list on display unit 40. When outputting information indicating the arrangement determined by arrangement determining unit 14, display control unit 13 may display the arrangement on display unit 40 using a 3D CAD (3Dimensions Computer Aided Design) model. Display control unit 13 may be equipped with a function to display information.

Arrangement determining unit 14 determines an arrangement of each of the parts in a component composed of these parts based on the spatial information and the shape and dimensions of each of the parts constituting the combination selected from the combinations displayed on display device 40 by display control unit 13. The details of this determination method are next described.

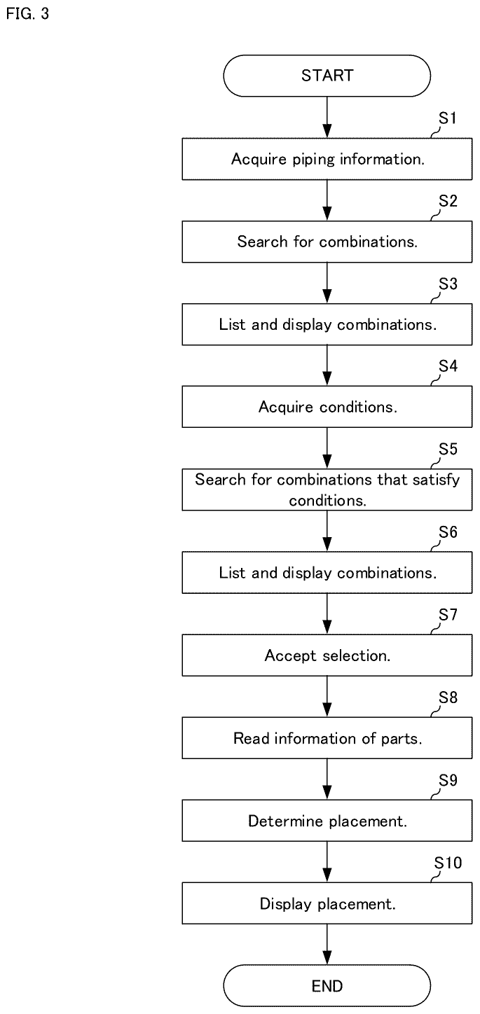

The design support method in the embodiment shown in FIG. 1 is next described. FIG. 3 is a flowchart for explaining an example of a design support method in the embodiment shown in FIG. 1. In the following explanation, we will use a case in which the component the support component supports is piping and display control unit 13 is a display that displays information.

First, display control unit 13 displays a predetermined input screen, and information acquisition unit 11 accepts operations on the displayed input screen to acquire piping information (Step S1). Piping information includes information of the piping (size, material, shape, insulating performance, etc.) for which the support component is to be installed (attached), as well as loads and stresses of insulation and fluids. Of the piping information, spatial information such as the shape, i.e., size and orientation, presence or absence and type of insulation (heat-retaining, cold-retaining, soundproofing, thickness, etc.), shape of steel support frame and the distance between the piping and the support frame may be automatically acquired from a 3D CAD model and thus input. Search unit 12 then searches database 20 for combinations of parts constituting support components for supporting the piping indicated by the piping information acquired by information acquisition unit 11 that has been placed in association with this piping information (Step S2). At this time, search unit 12 may search database 20 for combinations of parts constituting support components suitable for the piping information acquired by information acquisition unit 11. Alternatively, as described above, search unit 12 may calculate a combination of parts that can constitute a support component capable of supporting piping and that satisfies the parameters and characteristics included in the piping information. Search unit 12 may search database 20 for the calculated combination of parts. Display control unit 13 then lists and displays the combinations of the plurality of parts retrieved by search unit 12 in Step S2 (Step S3).

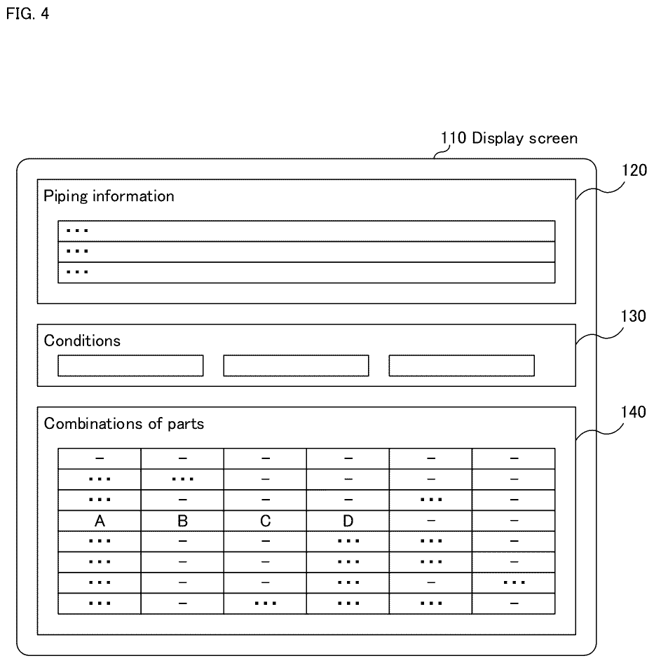

FIG. 4 shows an example of a display screen displaying combinations of parts in Step S3. As shown in FIG. 4, display screen 110 displayed by display control unit 13 includes section 120 for entering (displaying) piping information, section 130 for entering (displaying) conditions, and section 140 for displaying combinations of parts. Section 120 is an area in which the display prompts the user to enter piping information and in which the piping information entered in Step S1 based on external operations is displayed. Section 140 is an area in which the combinations of parts are displayed in Step S3. Section 130 is an area in which the display prompts the user to enter the conditions for supporting the piping (conditions of the support component), and in which, based on external operations, the conditions to be entered in Step S4 described below are displayed.

Information acquisition unit 11 next acquires the conditions of the support component for supporting the piping by receiving operation to section 130 of the display screen that is displayed as shown in FIG. 4 (Step S4). The conditions entered in section 130 consist of information for narrowing down the combinations by specifying such factors as the function, material, size, shape, and insulating performance required for the desired support component. Also, the entry of information in section 130 allows the desired parts to be specified from among the parts included in the combinations displayed in section 140 in Step S3. In section 130, conditions may be selected (entered) using a pull-down menu with multiple pre-set conditions. Search unit 12 then searches database 20 for combinations of parts that satisfy the conditions acquired by information acquisition unit 11 (Step S5). Here, search unit 12 searches database 20 for combinations of parts that satisfy the conditions acquired by information acquisition unit 11 from the combinations of parts searched in Step S2. In other words, the process in Step S5 is to narrow down the results of the search process in Step S2 according to the conditions. Display control unit 13 then lists and displays the combinations of parts retrieved by search unit 12 in Step S5 (Step S6).

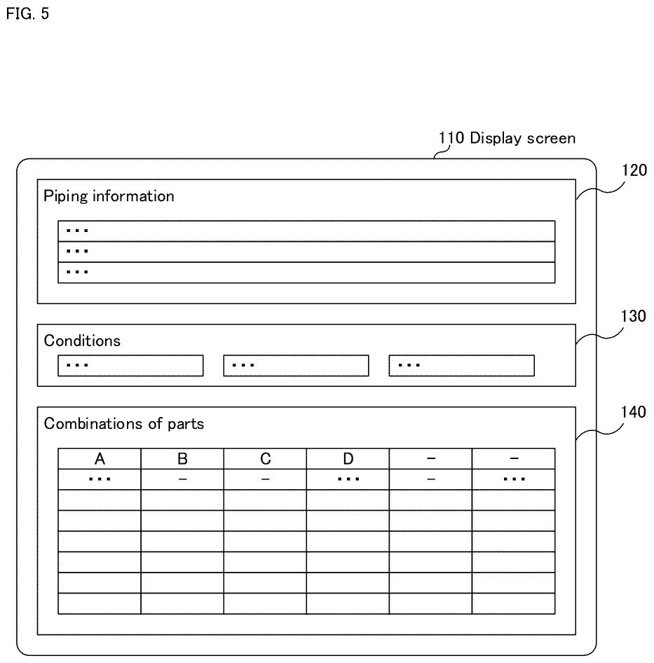

FIG. 5 shows an example of a display screen displaying combinations of parts in Step S6. As shown in FIG. 5, display screen 110 displayed by display control unit 13 displays sections 120, 130, and 140, similar to those shown in FIG. 4. At this time, the conditions entered in Step S4 are displayed in section 130. In section 140, of the combinations of parts displayed in section 140 shown in FIG. 4, only the combinations of parts retrieved by search unit 12 in Step S5 are displayed. When one of the parts displayed in section 140 is selected based on an external operation, an image drawing including the shape and dimensions of the part may be displayed on display screen 110.

Subsequently, when one of the combinations of parts displayed in section 140 in Step S6 is selected (Step S7), search unit 12 reads the information (specifications) of the selected parts from database 20 (Step S8). This selection can be based on an externally accepted selection operation for the combination of parts displayed in section 140 in Step S6. For example, when a touch panel is configured to realize information acquisition unit 11 and display control unit 13, information acquisition unit 11 may select, of the combinations of parts displayed in section 140 of display control unit 13, the combination of parts that is displayed at the position at which proximity or contact to the touch panel is detected, or information acquisition unit 11 may select a combination of parts that is selected in section 140 via a keyboard or mouse.

Arrangement determining unit 14 then determines an arrangement of each of the parts in the component composed of those parts based on the shape and dimensions of each of the parts read out in Step S8 and the spatial information contained in the piping information acquired in Step S1 (Step S9). Display control unit 13 displays on display unit 40 information indicating the arrangement determined by arrangement determining unit 14 (Step S10).

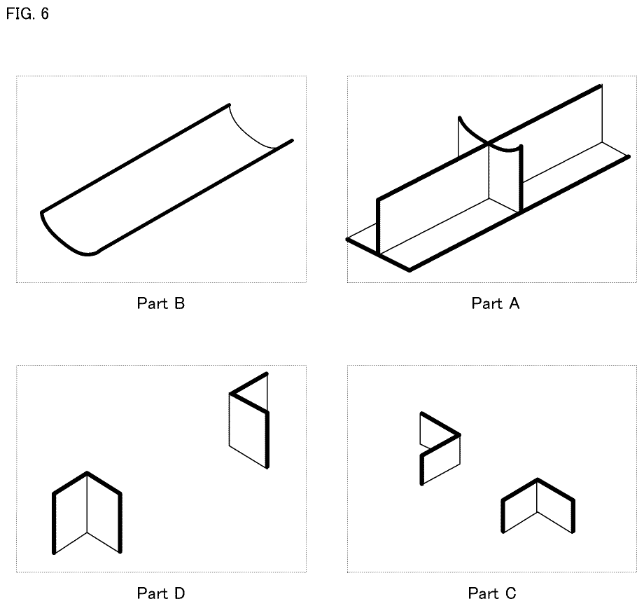

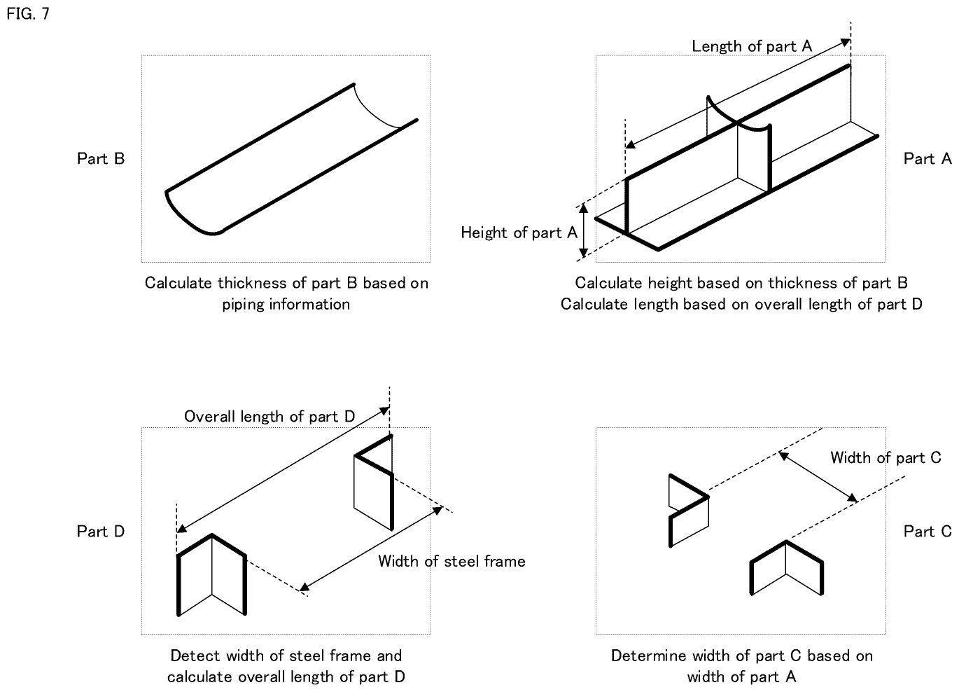

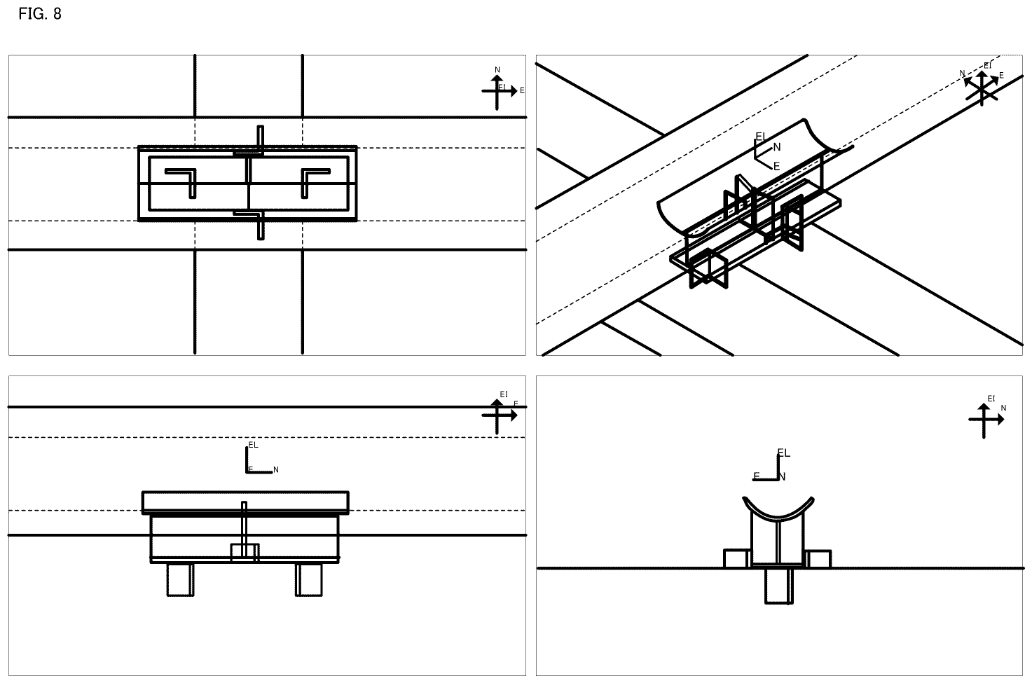

FIG. 6 shows an example of a part read from database 20 in Step S8. FIG. 7 is a figure for explaining an example of the specific process of determining the arrangement of parts by arrangement determining unit 14 in Step S9. FIG. 8 shows an example of a display of the arrangement of parts that is displayed on display unit 40 by display control unit 13 in Step S10. An example of a case is next described in which a combination of parts A, B, C, and D is selected and read from database 20 from among combinations of parts displayed in section 140 in FIG. 5.

As shown in FIG. 6, a combination of parts A, B, C, and D that satisfies the conditions is selected from among the combinations of parts that constitute a support component that supports the piping indicated by the input piping information. The arrangement of these selected parts A, B, C, and D is determined based on their respective shapes and dimensions. As shown in FIG. 7, the thickness of part B is calculated based on the piping information. For part D that, consists of two parts, the overall length when arranged is determined based on the width of the steel frame used when assembling the piping. The height of part A is determined based on the thickness of part B, and its length is determined based on the overall length of part D. The spacing of the two constituent parts of Part C (the open space between the parts) is determined based on the width of part A. The arrangement of Parts A to D in a support component consisting of parts A to D is determined based on these determined values.

As shown in FIG. 8, an image of a support component with each part assembled in the arrangement determined by arrangement determining unit 14 and attached to the piping is displayed as seen from multiple directions. In the example shown in FIG. 8, the placement of the parts is displayed using a 3D CAD model. The piping and the supporting members that support it are shown as a partially transparent view, with the attachment of each part visible. In the support component, the arrangement of the parts constituting the support component is visibly displayed.

Thus, in this embodiment, a list of the combinations of parts that constitute a support component that supports piping is output. Design support device 10 searches database 20 for combinations of parts that satisfy the entered conditions from among the combinations included in that list. Design support device 10 determines the arrangement of the parts in a component composed of those parts based on the shape and dimensions of each of the parts that make up the combination selected from among the retrieved combinations of parts. Design support device 10 then outputs the determined arrangement, thus allowing easy arrangement of the parts that make up the support component. Beyond support components, carrying out the same process for parts that make up any given component can facilitate the arrangement of parts that make up that component.

In this embodiment, if, for example, the pipe size of the piping information acquired in Step S1 is altered, arrangement determining unit 14 can also cause the arrangement of the parts that make up the selected support component or the parts themselves to be changed to follow the altered information. In this case, arrangement determining unit 14 may change the size of the parts that make up the support component and the spacing of the plurality of parts with respect to each other in response to changes in the size of the piping. For example, in response to a change in the size of the piping, arrangement determining unit 14 may increase the length of the parts that make up the support component, increase the spacing between each of the plurality of parts, or change the shape of the parts. If some of the parts whose placement has been determined in Step S9 are changed, it is also possible to have other parts whose placement has been determined adapt to the changed information. For example, the determination of arrangement in Step S9 may be carried out while changing the size and placement of other parts or the other parts themselves according to the changed parts. In this case, in response to the change in parts, arrangement determining unit 14 may change the size and shape of other parts that make up the support component and the spacing of the plurality of parts with respect to each other.

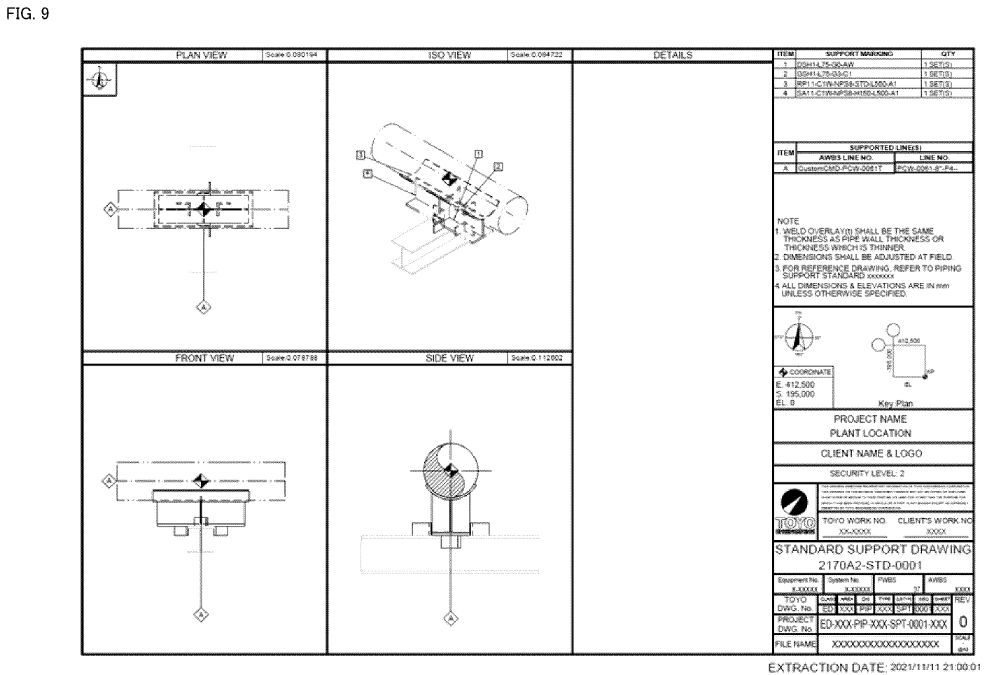

In this embodiment, design support device 10 may aggregate each of the parts comprising an arrangement displayed on display device 40 in Step S10 as a list of parts that make up one support component. Display control unit 13 displays the created list on display unit 40. In addition to specifications such as size and shape of the parts, the list may include a diagram showing the appearance of the parts and the position of each part in the support component. These figures may be displayed using a 3D CAD model. FIG. 9 shows an example of a drawing displayed using a 3D CAD model. As shown in FIG. 9, the constituent parts are displayed as drawings along with their arrangement. Design support device 10 may also store information indicating the created list in a memory (not shown) or database 20.

Although the invention has been described above by assigning each function (process) to a respective constituent element, these assignments are not limited to those described above. In addition, regarding the configuration of the constituent elements, the above-described embodiment is merely an example, and the present invention is not limited thereto.

The processing performed by each of the above constituent elements may be performed by logic circuits manufactured according to the purpose. Further, a computer program (hereinafter, referred to as a “program”) in which the processing contents are described as procedures may be recorded on a recording medium that can be read by design support device 10 equipped with each constituent element, and the program recorded on the recording medium may be read into and executed by design support device 10. The recording medium that can be read by design support device 10 may be a memory or an HDD (Hard Disc Drive) such as ROM (Read Only Memory), RAM (Random Access Memory), or the like incorporated in design support device 10, or may further be a transferable recording medium such as a floppy (registered trademark) disk, a magneto-optical disk, a DVD (Digital Versatile Disc), a CD (Compact Disc), a Blu-ray (registered trademark) Disc, or a USB (Universal Serial Bus) memory. The program recorded on the recording medium is read by a CPU provided in design support device 10, and the same processing as that described above is performed under the control of the CPU. Here, the CPU operates as a computer that executes a program read from a recording medium on which the program is recorded. The logic circuits described above may be realized using an FPGA (Field Programmable Gate Array).

While the present invention has been described above with reference to embodiments, the present invention is not limited to the above embodiments. Various changes within the scope of the present invention that will be understood by those skilled in the art can be made in the configuration and details of the present invention.

This application claims priority based on JP 2021-209686 filed on Dec. 23, 2021 and incorporates all of its disclosure herein.

1. A design support device, comprising:
an information acquisition unit that acquires spatial information and conditions for constructing a component;
a search unit that searches a database for combinations of parts that satisfy the conditions acquired by the information acquisition unit;
a display control unit that displays on a display device a display screen showing the combinations of parts retrieved from the database by the search unit; and
an arrangement determining unit that determines an arrangement of the parts in the component based on the spatial information and the shape and dimensions of each of the parts constituting a combination selected from among the combinations displayed on the display device by the display control unit, wherein
the display control unit displays on the display device information indicating the arrangement determined by the arrangement determining unit.

2. The design support device according to claim 1, wherein
the component is a support component that supports piping.

3. The design support device according to claim 2, wherein:
the information acquisition unit acquires information of the piping, and
the search unit searches the database for combinations of parts constituting a support component that supports piping based on the information acquired by the information acquisition unit and then searches the database for combinations of parts that satisfy the conditions acquired by the information acquisition unit from among the searched combinations of parts.

4. The design support device according to claim 2, wherein:
when the size of the piping is changed, the arrangement determining unit changes the parts or changes the arrangement of the parts according to the change.

5. The design support device according to claim 2, wherein:
when a part is changed, the arrangement determining unit changes parts other than the part or changes the arrangement of parts other than the part according to the change.

6. The design support device according to claim 1, wherein:
the display control unit displays the information indicating the arrangement of parts determined by the arrangement determining unit on the display device using a 3D CAD model.

7. The design support device according to claim 1, wherein:
the display control unit displays on the display device a list of combinations retrieved from the database by the search unit.

8. The design support device according to claim 1, wherein:
each of the parts for which the arrangement determining unit has determined arrangement is aggregated as a list of constituent parts that make up a single component, and
the display control unit displays the list on the display device.

9. The design support device according to claim 8, wherein:
the list includes at least one of the following: information indicating the sizes and shapes of the parts and a diagram indicating the outer appearance, and a diagram indicating the position of each of the parts in the component.

10. A design support method, comprising:
a process for acquiring spatial information and conditions for constructing a component;
a process for searching a database for combinations of parts that satisfy the acquired conditions for constructing the component;
a process for outputting the combinations of parts retrieved from the database;
a process for determining an arrangement of the parts in the component that comprises the parts based on the spatial information and the shape and dimensions of each of the parts that make up a combination selected from among the output combinations; and
a process for outputting information indicating the determined arrangement.

11. A recording medium storing a program for causing a computer execute procedures, the procedures comprising:
a procedure for acquiring spatial information and conditions for constructing a component;
a procedure for searching a database for combinations of parts that satisfy the acquired conditions for constructing the component;
a procedure for outputting the combinations of parts retrieved from the database;
a procedure for determining an arrangement of the parts in the component constituted using the parts based on the spatial information and the shape and dimensions of each of the parts constituting a combination selected from among the output combinations; and
a procedure for outputting information indicating the determined arrangement.
